(19) United States
(12) Patent Application Publication
(10) Pub. No.: US 2024/0253749 A1
(43) Pub. Date: Aug. 1, 2024

(54) MARINE ADAPTIVE BATTERY LOCATION SYSTEM

(71) Applicant: Polaris Industries Inc., Medina, MN (US)

(72) Inventors: Blair Alan Donat, Osceola, IN (US); Erik Rogers, Bristol, IN (US); Benjamin D. Duke, Beaver Dam, WI (US)

(21) Appl. No.: 18/428,520

(22) Filed: Jan. 31, 2024

Related U.S. Application Data
(60) Provisional application No. 63/442,251, filed on Jan. 31, 2023.

(51) Int. Cl. B63B 39/02; B63B 35/34; B63B 79/10; H01M 50/204; H01M 50/249

(52) U.S. Cl. CPC B63B 39/02; B63B 35/34; B63B 79/10; H01M 50/204; H01M 50/249; H01M 2220/20

(57) ABSTRACT

A dynamic adaptive ballasting system for selectively positioning batteries within the hull of a watercraft. For pontoon boats, the ballasting system may be disposed in a pontoon log, for example a middle pontoon log disposed between two outer pontoon logs. The ballasting system enables the balance and weight distribution of the watercraft to be dynamically adjusted for enhanced stability and performance.

### RELATED CASES

This application claims priority to U.S. Provisional Application 63/442,251 filed Jan. 31, 2023, entitled MARINE ADAPTIVE BATTERY LOCATION SYSTEM, the contents of which are expressly incorporated by reference herein.

### BACKGROUND OF THE DISCLOSURE

Pontoon boats have gained a reputation for smooth rides and the ability to transport a large number of passengers comfortably. A challenge for pontoon boat manufacturers has been offering many sizes and configurations of pontoon boats, with different motor options, while still maintaining the combined characteristics of speed and a smooth and comfortable ride for passengers, along with desired handling capabilities. Systems and methods for meeting these challenges, as well as enhancing these same characteristics in watercraft generally, would be welcomed.

### SUMMARY OF THE DISCLOSURE

Various embodiments of the disclosure include a ballasting system that balances a watercraft by positioning a weight ballast to counter imbalances in the weight distribution of the watercraft. Such imbalances may be caused by uneven distribution of watercraft cargo and/or occupants. In some instances, watercraft operation may cause a given weight distribution that was effectively balanced for one operating condition to be imbalanced in another operating condition, for example when suddenly accelerating from an at rest condition to achieve high velocities, such as when getting on plane with water skiers in tow. The disclosed system and methods provide dynamic positioning of the weight ballast for enhanced balance as the operating conditions of the watercraft change.

Various embodiments of the disclosure are suited for addressing the challenges of balancing of electric-powered watercraft. As electric-powered watercraft evolve and become more robust, additional battery capacity will need to be added. Consider that electric car batteries usually weigh from roughly 20% to 25% of the total car weight. In the case of watercraft, which by nature are much lighter than an automobile, the fraction of weight attributed to batteries may be substantially greater. The increased weight ratio of the batteries could negatively impact watercraft performance and may not be amenable to a fixed placement solution that works for all operating conditions of a given watercraft. Accordingly, some embodiments of the disclosure utilize batteries as the weight ballast. The disclosed adaptive battery positioning moves the batteries within the hull of the watercraft, thus leveraging the substantial weight inherent to electric powered watercraft as a way to adjust and balance the weight distribution.

### BRIEF DESCRIPTION OF THE DRAWINGS

FIG. 1A is a perspective bottom view illustrating the positioning of an adaptive weight ballasting system within the hull of a watercraft according to an embodiment of the disclosure;

FIG. 1B is a side elevational view of the watercraft of FIG. 1A;

FIG. 1C is a top plan view of the watercraft of FIG. 1A;

FIG. 1D is a front elevational view of the watercraft of FIG. 1A;

FIG. 2 is a perspective representation of a hull and platform of a pontoon boat with an adaptive weight ballasting system according to an embodiment of the disclosure;

FIG. 3 is a schematic of an adaptive weight ballasting system according to an embodiment of the disclosure;

FIG. 4 is a flow diagram for automatic control of the adaptive weight ballasting system according to an embodiment of the disclosure;

FIG. 5A is a perspective view of a pontoon boat with a battery stowage system having batteries in a forward position according to an embodiment of the disclosure;

FIG. 5B is the pontoon boat of FIG. 5A depicting batteries in a rearward position;

FIG. 6A is a bottom view of the pontoon boat of FIG. 5A depicting batteries in a central position;

FIG. 6B is a bottom view of the pontoon boat of FIG. 5A depicting batteries in a forward position;

FIG. 6C is a bottom view of the pontoon boat of FIG. 5A depicting batteries in various positions;

FIG. 7 is a perspective view of a tray and track system according to an embodiment of the disclosure;

FIG. 8 is a side view of a battery stowage system within a pontoon according to an embodiment of the disclosure;

FIG. 9 is a side view of a battery stowage system within a hull according to an embodiment of the disclosure;

FIG. 10A is a top view of a hull with a battery stowage system in a first position according to an embodiment of the disclosure; and

FIG. 10B is a top view of the hull of FIG. 10A with the battery stowage system in a second position.

### DETAILED DESCRIPTION OF THE FIGURES

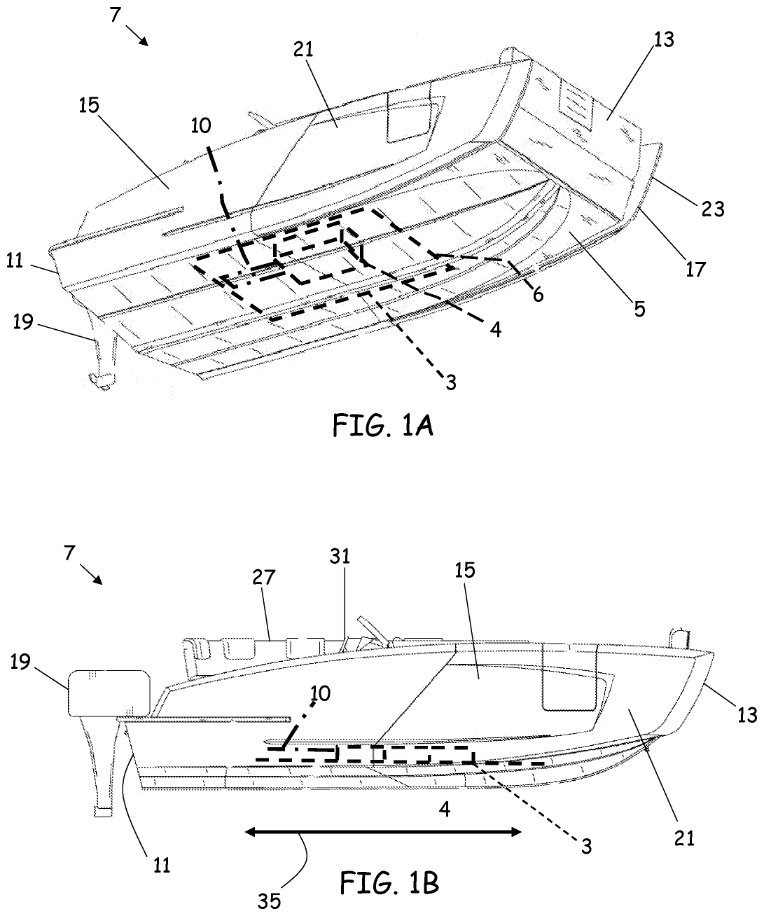

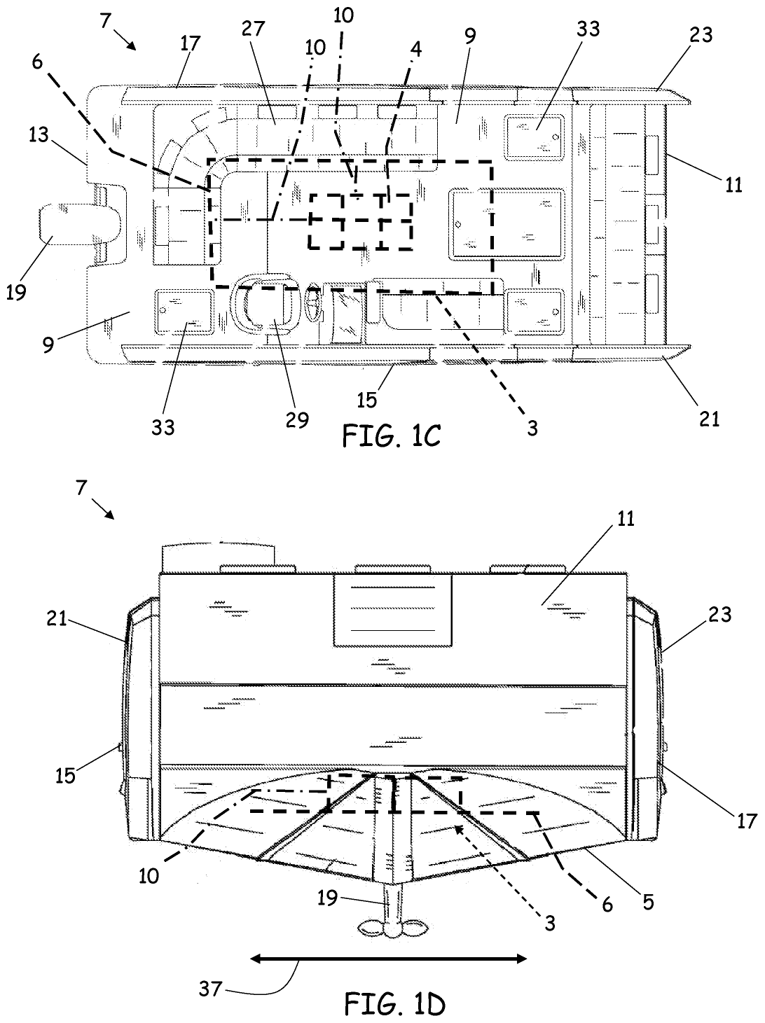

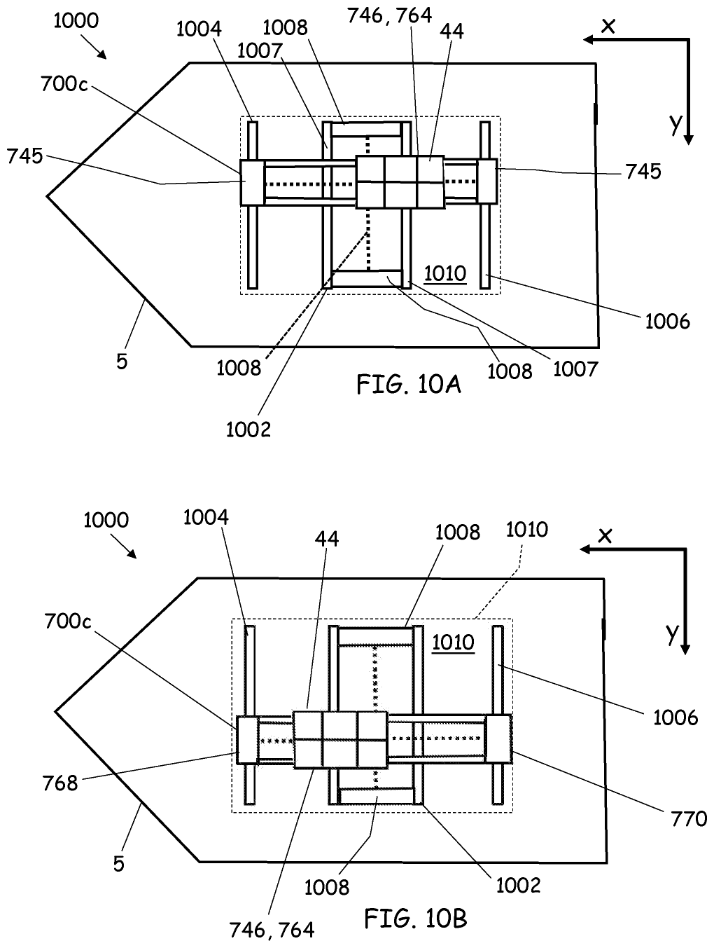

Referring to FIGS. 1A-1D, an adaptive weight ballasting system 3 is depicted in a hull 5 of a watercraft 7 according to an embodiment of the disclosure. A watercraft 7 may include a hull 5, supporting a deck 9, the adaptive weight ballasting system 3, shown in dashed lines, being positioned within a cavity below the deck and within the hull 5. The adaptive weight ballasting system 3 including a weight ballast 4 which may be a cluster of batteries, and a translation stage 6 which provides movement capability and range of the weight ballast in the hull, and a positioning system 10, depicted schematically by a dot dash line, that positions weight ballast 4. One or more positioning systems 10 may move the weight ballast in a stern-bow direction, a port-starboard direction, or another direction. Positioning system embodiments are described further below. The translation stage 6 may be a track or other structure providing movement capability of the weight ballast 4, embodiments described further below. See FIGS. 9-10B and associated text. The hull 5 and deck 9 may extend from an bow 11 of the watercraft 7 to a stern 13, and from a starboard side 15 to a port side 17. Engine 19, which may be an electric engine, may be mounted to the stern 13 of the watercraft 7. Additional structure, such as sponsoons 21, 23 may be fixed to port and starboard edges of the hull 5. The deck 9 may support various passenger seating 27, an operator chair 29, and an operator console 31. Hatches 33 in the deck 9 may provide access to the weight ballasting system 3 or other cavities or storage areas within the hull 5.

As will be discussed in more detail below, the weight ballasting system 3 may translate within the hull 5 to main proper balance of the watercraft 7. The weight ballasting system 3 may translate in various directions. For example, as indicated by the arrows 35 in FIG. 1B, the weight ballasting system 3 may translate between the bow 11 and stern 13 of the boat 7. In another example, as indicated by the arrows 37 in FIG. 1D, the weight ballasting system 3 may translate in the port and starboard directions. In further embodiments, the weight ballasting system may lift or lower, thereby translating in a vertical direction.

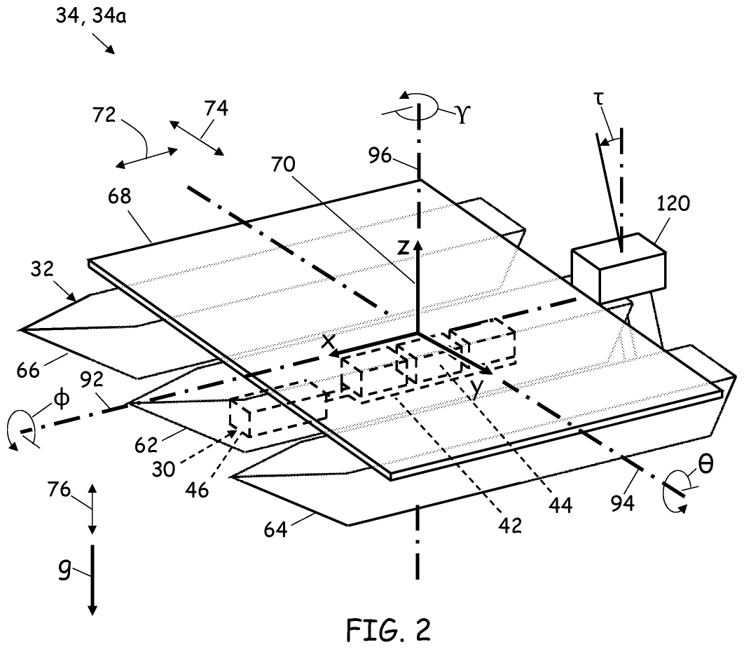

Referring to FIG. 2, an adaptive weight ballasting system 30 is depicted in a hull 32 of a watercraft 34 according to an embodiment of the disclosure. The watercraft may be a pontoon boat or a single hull boat. In embodiments, the adaptive weight balancing system is in a recreational pontoon boat of a length of from 12 feet to 26 feet. In embodiments the adaptive weight balancing system is recreational pontoon boat of from 14 feet to 34 feet. In embodiments, the adaptive weight balancing system is in non-pleasure boats. In embodiments the adaptive weight balancing system may be in personal water craft often referred to such as jet skis. The adaptive weight ballasting system 30 includes a translation stage 42 seated within the hull 32, a weight ballast 44 mounted to the translation stage 42, and a positioning system 46 coupled to the translation stage 42. In the depicted embodiment, the watercraft 34 is a pontoon boat 34a with the hull 32 comprising a middle pontoon log 62 disposed between outer pontoon logs 64 and 66. A platform 68 coupled to the hull 32 is also depicted. The use of the adaptive weight ballasting system 30 is not limited to pontoon boats 34a. That is, a person of ordinary skill in the pertinent watercraft arts, in view of this disclosure, recognizes that the weight ballasting systems depicted and described herein may be applied mutatis mutandis to other watercraft hulls.

A coordinate system 70 is depicted in FIG. 2 defining x-y-z (Cartesian) coordinates that are at right angles to each other. The x-coordinate extends parallel to a fore/aft direction of the hull 32, also referred to herein as the “axial” direction(s) 72. The y-coordinate extends perpendicular to the x-axis in what is referred to herein as the “lateral” direction(s) 74. The z-coordinate is parallel to a gravity vector g, defining what is herein referred to as the “vertical” direction(s) 76. The origin of the coordinate system 70 is arbitrary but in fixed relation to the hull 32, with the z-coordinate always parallel to the gravity vector g. As such, the x-y plane of the coordinate system 70 defines horizontal. A roll axis 92 is coincident with the x-coordinate, about which a roll angle ϕ relative to horizontal is defined. A pitch axis 94 is coincident with the y-coordinate, about which a pitch angle θ is defined relative to horizontal. A yaw axis 96 may also be defined as coincident with the z-coordinate, about which a yaw angle γ is defined relative to the x-coordinate.

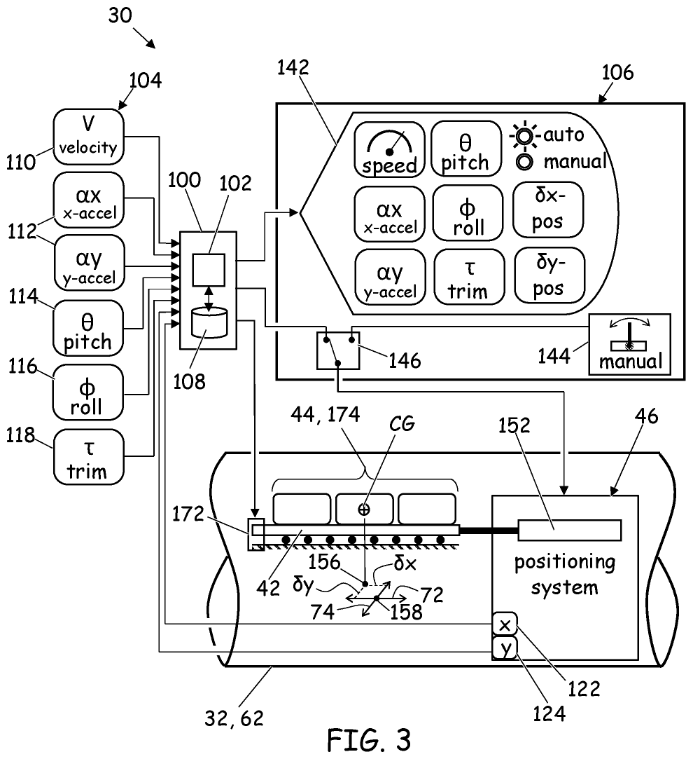

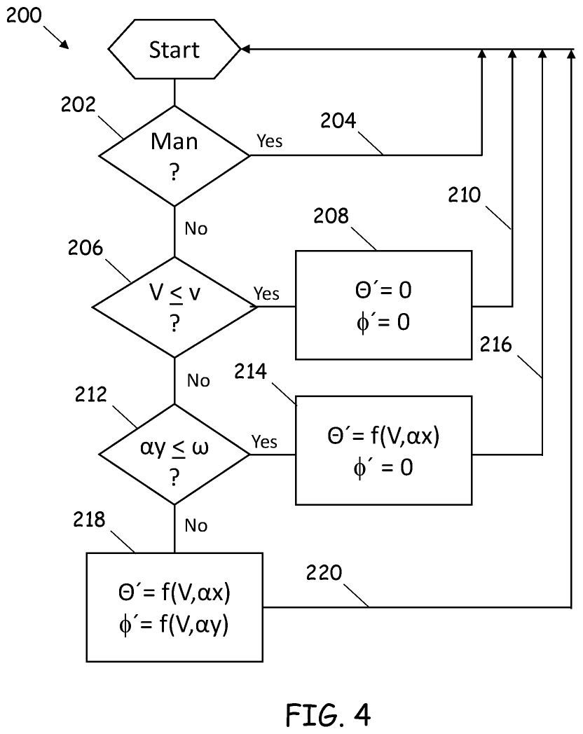

Referring to FIG. 3, the adaptive weight ballasting system 30 is depicted in greater detail according to an embodiment of the disclosure. In addition to the translation stage 42, weight ballast 44, and positioning system 46 seated within the hull 32 (e.g., middle pontoon log 62), the adaptive weight ballasting system 30 may include a data acquisition system 100 that receives input from one or more instruments 104 and outputs to one or more of a control console 106, the positioning system 46, and the translation stage 42. In some embodiments, the data acquisition system 100 includes a controller 102 that executes instructions accessed from a tangible, non-transient medium 108, such as a computer-readable storage device (e.g., hard disk, flash drive, cartridge, firmware). The instructions may embody the techniques and methods depicted or described herein for control of the adaptive weight ballasting system 30 (e.g., the automatic control method 200 at FIG. 4). In some embodiments, the controller 102 can also write to the medium 108 (or a separate medium), for example to store data acquired from the instruments 104. The instruments 104 may include one or more of: a velocity sensor 110 that monitors an axial velocity V (speed) of the watercraft 34; one or more accelerometer(s) 112 that generate signals indicative of an axial acceleration/deceleration αx of the watercraft 34 in the axial directions 72 and, in some embodiments, an acceleration/deceleration αy in the lateral directions 74; a pitch sensor 114 that generates signals indicative of the pitch angle θ of the hull 32 or platform 68 relative to a reference state (e.g., relative to horizontal); a roll sensor 116 that generates signals indicative of the roll angle ϕ of the hull 32 or platform 68 relative to a reference state (e.g., relative to horizontal); a trim sensor 118 that generates signals indicative of the trim angle τ of a boat motor 120 (FIG. 1); a first position sensor 122 that determines an axial location of the weight ballast 44 relative to a reference location; and a second position sensor 124 that determines a lateral location of the weight ballast 44 relative to the reference location. In some embodiments, the pitch sensor 114 and/or roll sensor 116 are coupled to the platform 68.

The control console 106 provides one or more interfaces for the operator, and may be proximate a helm of the watercraft 34. In some embodiments, the control console 106 includes a display 142 that posts information from the instruments 104 that is transmitted by the data acquisition system 100. The control console 106 may include a manual interface 144 for manually controlling the positioning system 46. Examples of the manual interface 144 include a lever, turn dial, slide, joystick, touchpad, or touchscreen. The manual interface 144 may be separate from the display 142 (depicted) or integral to the display 142. In some embodiments, a switch 146 enables the operator to select either automatic control as provided by the controller 102 or manual control with the manual interface 144.

The positioning system 46 may include one or more actuators 152 for manipulating the translation stage 42. The actuator(s) 152 are arranged to drive the translation stage 42 in at least the axial directions 72. In some embodiments, actuator(s) 152 are arranged to drive the translation stage 42 in both the axial and lateral directions 72 and 74. The actuator(s) 152 may be driven, for example, by hydraulics, pneumatics, electric motors, or other drives available to the artisan. The positioning system may also use other mechanical motion systems such as a motor driven sprocket connecting to a chain, a rope drive, rack and pinion mechanism, or a screw drive, or other systems known to the artisan.

The positioning system 46 may also include the one or more position sensors 122, 124 that detect a representative location 156 of the translation stage 42. The representative location 156 may correspond to a fixed point on the translation stage 42, for example a point that is vertically aligned with a center of gravity CG of the weight ballast 44 (depicted) or a corner of the translation stage 42. The representative location 156 may be referenced to a reference location 158 to measure or otherwise determine a displacement of the translation stage 42 relative thereto. The position sensor(s) 122, 124 may provide a signal from which an axial displacement δx of the representative location 156 relative to the reference location 158 can be determined. In some embodiments, the position sensor(s) 122, 124 provide an additional signal from which a lateral displacement δy of the representative location 156 relative to the reference location 158 can also be determined. The position sensor(s) 122, 124 may be a component(s) of the positioning system 46 (depicted) that provides a repeater or other output signal corresponding to the representative location 156 for detection by the controller 102. Alternatively, the position sensor(s) 122, 124 may be separate from the positioning system 46.

In some embodiments, a remote actuated clamp 172 is coupled to the translation stage 42 or hull 32 and arranged for selectively fixing a position of the translation stage 42. The remote actuated clamp 172 may be controlled by the positioning system 46, such that the remote actuated clamp 172 is released whenever the positioning system 46 energizes the actuator(s) 152 or otherwise executes a movement of the translation stage 42, and is set whenever the actuator(s) 152 is not energized or the positioning system 46 is not executing a movement. Actuation of the remote actuated clamp 172 may be provided, for example, by solenoid, servomotor, hydraulics, or pneumatics.

The adaptive weight ballasting system 30 may include aspects disclosed in U.S. Provisional Patent Application No. 63/431,345 to Donat et al., filed Dec. 9, 2022 and owned by the owner of the present application. In some embodiments, the weight ballast 44 comprises one or more batteries 174 that, for example, power the watercraft 34. The translation stage 42 may include various aspects disclosed by Donat et al. for supporting and translating the batteries 174, for example, telescoping rails or tray and track aspects, as well as support and routing of power cables connected to the batteries 174.

Functionally, in the parlance of closed loop control, movement of the weight ballast 44 within the hull 32 is a manipulated variable of a process that alters the pitch θ and, for embodiments so configured, roll ϕ of the platform 68, which are sensed by the pitch and roll sensors 114 and 116, respectively, as the controlled or feedback variables that are compared to pitch and roll setpoints θ′ and ϕ′. When the watercraft 34 is being powered by the motor 120, the trim angle τ may also be part of the process that alters the pitch θ and roll ϕ.

The positioning system 46 may locally resolve the representative location 156, for example in a local closed loop control scheme. Optionally, the positioning system 46 may operate locally in open loop control, with the separately provided position sensor(s) 122, 124 acting as feedback for closed loop control by the controller 102. In some embodiments, setpoints are established for the axial displacement δx (and lateral displacement δy for embodiments so equipped) and the positioning system 46 is assumed to achieve the displacement set points.

In some embodiments, the data acquisition system 100 continually updates the display 142 with instantaneous information from the instruments 104. For embodiments where the controller 102 can write to the medium 108, the adaptive weight ballasting system 30 can track the various generated signals over a time interval leading up to the instantaneous time, enabling, for example, time lapsed display of various parameters as well as the ability to compute trends in the data that may be utilized for control.

Referring to FIG. 4, the steps of an automatic control method 200 of the adaptive weight ballasting system 30 is depicted according to an embodiment of the disclosure. If the adaptive weight ballasting system 30 is in manual mode (step 202), the controller 102 does not execute the remainder of the automatic control method 200, and the controller 102 may continuously monitor the status of the switch 146 (loop 204) or otherwise stand by or terminate. The pitch setpoint θ′ is generally a function of the velocity V. That is, when the axial velocity V of the watercraft 34 is at or less than a predetermined threshold velocity v (step 206), the pitch setpoint θ′ is set at zero (step 208), corresponding to a horizontal condition for the platform 68. The automatic control method 200 may continuously monitor the mode status and velocity V (steps 202 and 206 in loop 204). When the watercraft 34 is being powered at a velocity V that is greater than the threshold velocity v, the pitch setpoint θ′ may generally be a non-zero value (steps 214, 218), for example to lift the bow high in the water. The prescribed or targeted pitch setpoint θ′ may also vary with the magnitude of the velocity V. In embodiments so equipped, pitch setpoint θ′ may also be a function of the axial acceleration αx (steps 214, 218). For embodiments that are configured to compensate for roll ϕ, the lateral acceleration αy may be below a threshold acceleration ω (step 212), for example when the watercraft is at rest or proceeding on a straight vector. When the lateral acceleration αy is at or less than the threshold acceleration ω (or is not sensed), the automatic control method 200 may continuously monitor the mode status, velocity V, and lateral acceleration αy (steps 202, 206, and 212 in loop 216). When the watercraft 34 is banking, the lateral acceleration αy may be greater than the threshold acceleration ω, and the automatic control method 200 may act to adjust the roll angle ϕ as the watercraft 34 proceeds through the banking. The targeted roll setpoint ϕ′ may be established as a function of the velocity V and the lateral acceleration αy (step 218) when the lateral acceleration αy greater than the threshold acceleration ω (step 212). During the banking, the automatic control method 200 may continuously monitor the mode status, velocity V, and lateral acceleration αy (steps 202, 206, and 212 in loop 220).

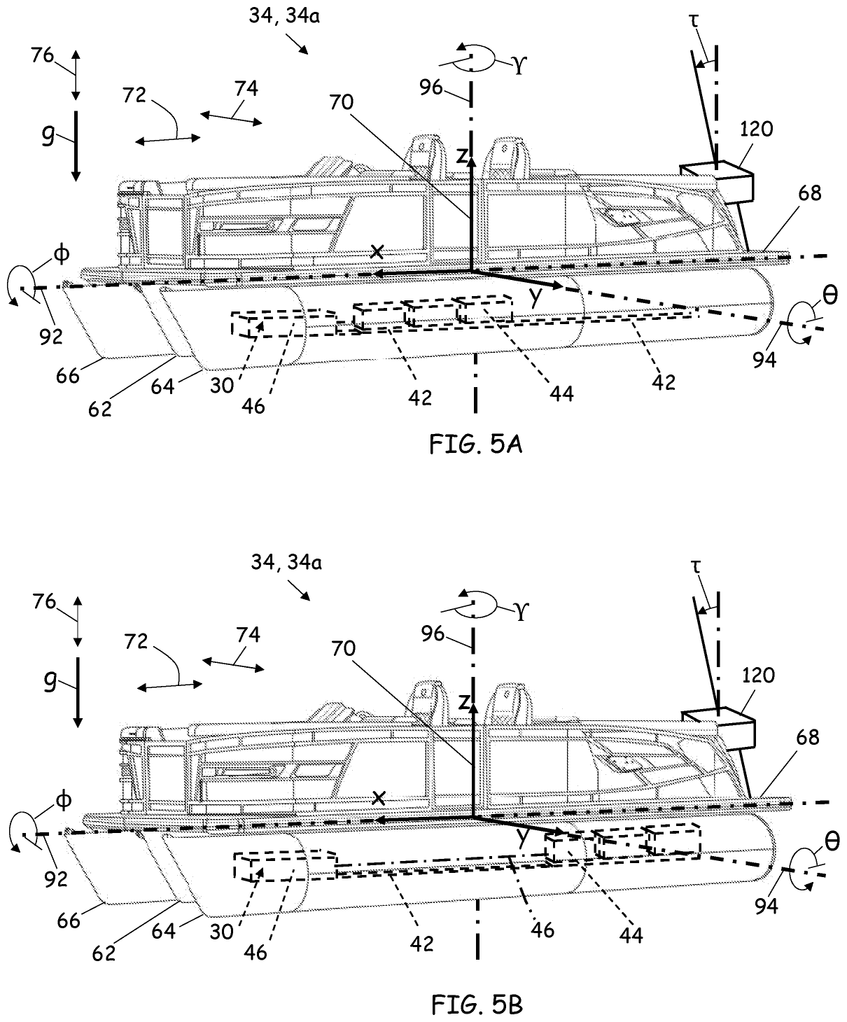

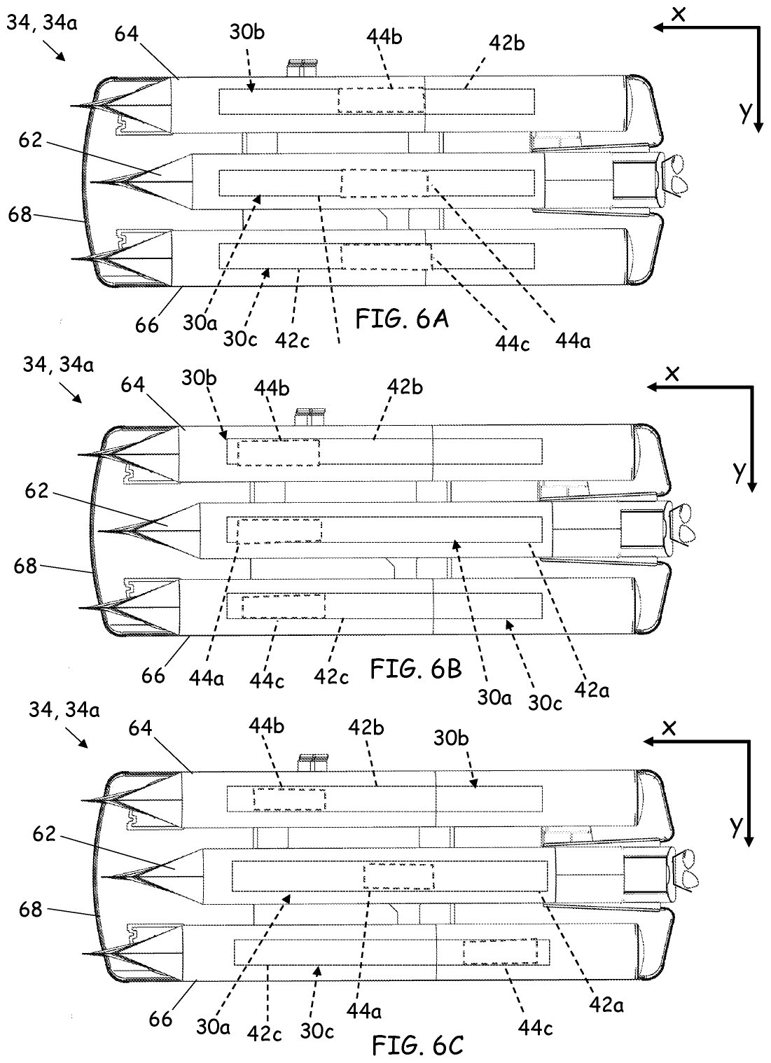

Referring to FIGS. 5A-5B and 6A-6C, exemplary movement of an adaptive weight ballasting system 30 is depicted within one or more pontoon logs 62, 64, 66 in the context of a pontoon boat 34a, according to an embodiment of the disclosure. Referring to FIGS. 5A and 5B, the adaptive weight ballasting system 30 includes a translation stage 42 seated within the pontoon log 64, a weight ballast, such as one or more batteries, 44 mounted to the translation stage 42, and a positioning system 46 coupled to the translation stage 42. Although the positioning system 46 is depicted in the forward or bow position, other locations are not beyond the scope of the disclosure. For example, positioning system 46 could be placed in a rearward or stern position. In some embodiments, a first positioning system may be located in a rearward position and a second positioning system may be located in a forward position, the first and second positioning systems working in concert to translate the weight ballast. Positioning system may be used to translate weight ballast 44 along the X axis, which is to say, in the bow to stern (or vice versa) direction. Referring specifically to FIG. 5A, weight ballast 44 is shown in a forward position within the pontoon log 64. Referring specifically to FIG. 5B, weigh ballast 44 is depicted in a rearward position with the pontoon log 64.

Referring to FIGS. 6A-6B, relative movements of weight ballast 44a, 44b, 44c along translation stage 42a, 42b, 42c is shown within pontoon logs 62, 64, 66. Referring specifically to FIGS. 6A and 6B, weight ballasts 44a, 44b, 44c are shown moving generally in unison along the translation stage 42a, 42b, 42c. In FIG. 6A, each of the weight ballasts 44a, 44b, 44c are generally centered within the respective pontoon logs 62, 64, 66 between the bow and stern of the pontoon boat 34a. In FIG. 6B, each of the weight ballasts 44a, 44b, 44c are positioned within the respective pontoon logs 62, 64, 66 towards the bow, or frontward portion, of the pontoon boat 34a, with each weight ballast 44a, 44b, 44c generally sharing a common position along the X axis. In contrast, FIG. 6C depicts each weight ballast 44a, 44b, and 44c at different positions along the X axis. As shown, the weight ballast 44a in the central pontoon log 62 is generally centered on the boat 34a, the port weight ballast 44b in the port pontoon log 64 is positioned in a forward or bow position, and the starboard weight ballast 44c withing the starboard pontoon log 66 is in a rearward or stern position. It is further understood that not all pontoon logs require a weight ballast system 30. For example, in embodiments, weight ballast system 30 may be located only in the central pontoon log 62. In some embodiments, weight ballast system 30 may located only in the port and starboard pontoon logs 64, 66 while the central pontoon log 62 remains empty. In embodiments, the adaptive weight balancing system may be positioned in a pontoon boat above the pontoons of a pontoon boat, the central pontoon may have a recess to accommodate the adaptive weight balancing system, and/or the adaptive weight balancing system may be positioned in the deck framework. In embodiments, the adaptive weight balancing system may be positioned between the two pontoons in a pontoon boat with only two pontoons. Such positioning in embodiments allows dual axis positioning in a pontoon boat as described with respect to a single hull boat in association with FIGS. 9-10B below.

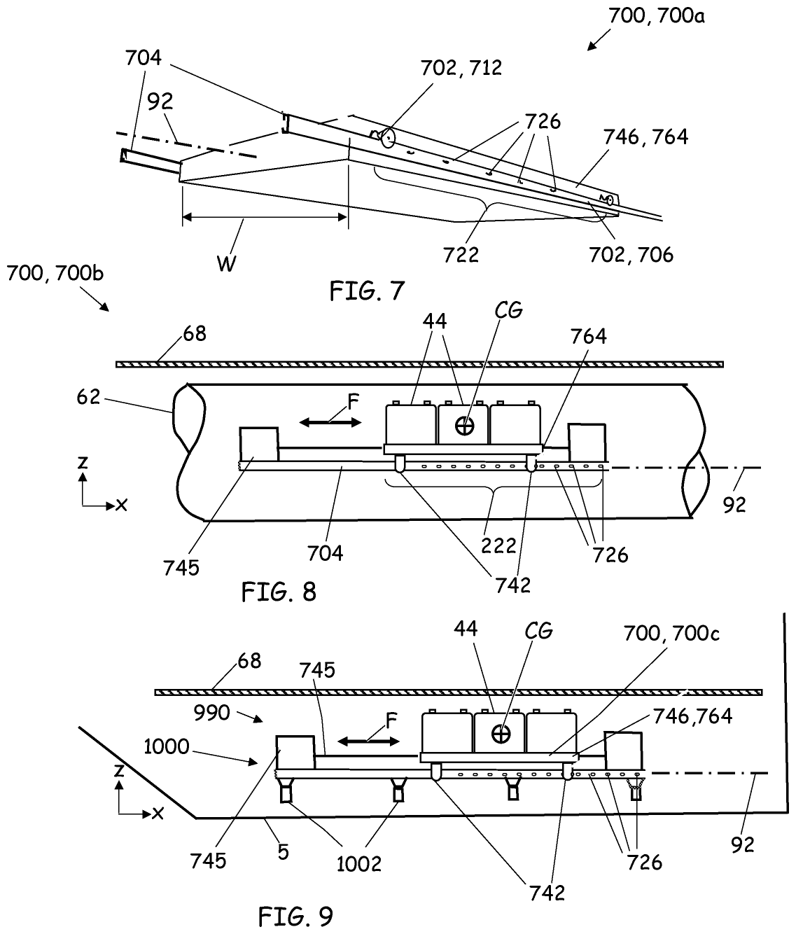

Referring to FIG. 7, a translation stage configured as a tray and track system 700 is depicted according to an embodiment of the disclosure. Track mounting fixtures 702 extend laterally beyond a width dimension W to capture the tray 746 between parallel tracks 704. The track mounting fixtures 702 may include low friction components 706 that slidingly mate with the tracks 704, such as wheels (depicted), roller bearings, or slides. In some embodiments, the track mounting fixtures 702 include clips or hooks 712 that seat on top of the parallel tracks 704 when the tray and track system 700 is at rest. The frame 764 or tray 746 may include linkage mechanisms, such as hooks or the link, for linking to additional frames or trays and/or for linking to a translation mechanism for pulling the tray 746 along the tracks 704. In some embodiments, a section 722 of the tracks 704 includes lock tabs 726. Herein, the tray and track system(s) are referred to generically or collectively by reference character 700, and individually or specifically by reference character 700 followed by a letter suffix (e.g., “tray and track system 700a”). In some embodiments, rails or tracks 704 may be curved or arcuate. In embodiments, tracks 704 may be concave facing upwardly.

Referring to FIG. 8, a translation stage configured as a tray and track system 700b is depicted according to an embodiment of the disclosure. The tray and track system 700b may include some of the same components and attributes as the tray and track system 700a, some of which are depicted with same-labeled reference characters. Distinctions of the tray and track system 700b relative to the tray and track system 700a include track mounting fixtures 742 mounted proximate to ends 743, 744 of the tray 746 that extend downward below the tray 746. The track mounting fixtures 742 may also include the low friction components 706 akin to the track mounting fixtures 702 of the tray and track system 700a. As shown, the tray and track system 700b may be mounted within a pontoon log 62. The tray and track system 700b may be mounted using straps, struts, legs, or the like. For example, straps secured to the frame 764 may be affixed to a surface of the pontoon log 62 such the tray and track system 700b is suspended within the interior of the pontoon log.

In some embodiments, the track mounting fixtures 742 extend laterally beyond the width dimension W of the frame 764 or tray 746. Alternatively, the track mounting fixtures 742 do not extend beyond the width dimension W of the frame 764 or tray 746, but instead are fully within the width dimension W. Operation of the tray and track system 700b is also depicted at FIG. 8. A force F may be exerted on the tray 746 is at rest on section 722 of the parallel tracks 704, for example by positioning system 745, such that the tray 746 with the longitudinal center of gravity CG at the desired location.

Referring to FIG. 9, a two axis weight ballast system 990 comprises a two axis translation stage 1000 configured as dual tray and track system shown mounted within a hull 5. The two axis translation stage 1000 that provides translation of the weight ballast 44 between the bow and stern and between the port and starboard sides. The dual tray and track system 1000 includes a first track and tray system 700c mounted on a secondary track system 1002 and rollingly or slidingly engaged therewith. Operation of the tray and track system 700c is also depicted at FIG. 9. A force F may be exerted on the tray 746 is at rest on section 722 of the parallel tracks 704, for example by first positioning system 745, such that the tray 746 with the longitudinal center of gravity CG at the desired location. The positioning system 745 is depicted as providing bow-stern positioning, an additional positioning system, not shown in this figure, may provide the port-starboard positioning of the first track and tray system 700c and first positioning system 745.

Referring to FIGS. 10A and 10B, a top view of the two axis weigh ballast positioning system 990 comprising the dual tray and track system 1000 is shown positioned within a hull 5 along. A dual translation stage 1000 may include a first tray and track system 700c, as generally shown and described above, that can translate the frame 764 and tray 746 in the bow and stern directions, along the X axis. The first tray and track system 700c may further be mounted on a secondary track system 1002, the secondary track system 1002 being generally orthogonal to the first tray and track system 700c. In embodiments, the secondary track system 1002 may be a tray and track system. In embodiments, the secondary track system 1002 may include an outside set of rails 1004, 1006 and inner rails 1008. Positioning systems 745 associated with the first tray and track system are connected thereto such that translation of the first track and tray system 700c also translates the positioning systems 745. First track and tray system 700c may slidingly or rollingly mount to outside rails 1004, 1006 and inner rails 1007. The secondary track system 1002 may 1002 may further be associated with a secondary positioning system 1008 configured to translate the first tray and track system 700c in the port and starboard along the Y axis. Accordingly, the weigh ballast 44 may be positioned anywhere in the hull 5 between the outside rails 1004, 1006, as generally shown by the dashed line box 1010. The first track and tray system 700c moves the weight ballast 44 along the X axis, and the secondary track system moves the weight ballast 44 along the Y axis (by translating the entire first tray and track system 700c), such that the weight ballast 44 is positionable anywhere within the area defined by the dual tray and track system 1000.

In embodiments, the translation system may be configured as a linkage system where the weight ballast is supported by a linkage system attached to the deck, hull, or framework of a watercraft; or the translation system may comprise a low friction surface, such as an HDPE surface, upon which a tray or frame supporting the weight ballast is slidingly engaged; or other embodiments known to artisans. In embodiments, the translation stage may be linkage systems may be combined with track systems, for example. In embodiments, the dual axis positioning system does not need to be in alignment with the bow-stern axis and port-starboard axis; for example the dual axis positioning system could be rotated 45 degrees from the positioning as shown in the figures. In such a case, two positioning systems could work in conjunction to move the weight ballast forward during an acceleration state, for example.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize, in view of this disclosure, that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art. The following document is hereby incorporated by reference herein and is attached hereto: U.S. Utility patent application Ser. No. 18/533,484 to Donat et al., filed Dec. 8, 2023. This document is incorporated by reference herein in its entirety, except for express definitions and patent claims contained therein unless expressly included herein, and such that no subject matter is incorporated that is contrary to the explicit disclosure herein.

The following clauses illustrate example subject matter described herein.

Clause 1. A dynamic adaptive ballast system for a watercraft, with a translation stage seated within a hull of a watercraft; a weight ballast mounted to said translation stage; and a positioning system coupled to said translation stage to selectively position said translation stage and said weight ballast within said hull.

Clause 2. The dynamic adaptive ballast system of clause 1, comprising a remote actuated clamp for securing said translation stage in a fixed relationship with said hull.

Clause 3. The dynamic adaptive ballast system of clause 1, comprising a manual interface for manual control of said positioning system.

Clause 4. The dynamic adaptive ballast system of clause 1, wherein said translation stage is arranged to translate said weight ballast axially within said hull.

Clause 5. The dynamic adaptive ballast system of clause 4, having a data acquisition system; and one or more instruments for monitoring by said data acquisition system.

Clause 6. The dynamic adaptive ballast system of clause 5, comprising a display for displaying parameters based on said input from one or more instruments.

Clause 7. The dynamic adaptive ballast system of clause 5, wherein said one or more instruments includes a pitch sensor that is monitored by said data acquisition system.

Clause 8. The dynamic adaptive ballast system of clause 7, wherein said data acquisition system includes a controller that receives a signal from said pitch sensor for control of said positioning system.

Clause 9. The dynamic adaptive ballast system of clause 7, wherein said data acquisition system includes a controller configured to control a pitch angle of said hull by axial translation of said weight ballast using said positioning system.

Clause 10. The dynamic adaptive ballast system of clause 9, comprising a remote actuated clamp operatively coupled to said controller for securing said translation stage in a fixed relationship with said hull.

Clause 11. The dynamic adaptive ballast system of clause 9, having a manual interface for manual control of said positioning system; and a switch for selecting one of said controller and said manual interface for control of said positioning system.

Clause 12. The dynamic adaptive ballast system of clause 9, wherein said controller is configured in a closed loop control process wherein an axial location of said weight ballast within said hull is a manipulated variable and said pitch sensor provides hull pitch data as a feedback element.

Clause 13. The dynamic adaptive ballast system of clause 12, wherein said one or more instruments includes a position sensor that detects a representative axial location of said weight ballast for said axial location of said weight ballast within said hull.

Clause 14. The dynamic adaptive ballast system of clause 9, where said one or more instruments includes a velocity sensor that outputs a velocity signal based on an axial velocity of said hull; and said controller detects an output from said pitch sensor and targets a pitch setpoint for said pitch sensor that is a function of said axial velocity of said hull.

Clause 15. The dynamic adaptive ballast system of clause 9, where said one or more instruments includes an acceleration sensor that outputs an acceleration signal based on an axial acceleration of said hull; and said controller detects an output from said pitch sensor and targets a pitch setpoint for said pitch sensor that is a function of said axial acceleration of said hull. use

Clause 16. The dynamic adaptive ballast system of clause 9, where said controller adjusts a trim angle of a boat motor based on a pitch angle setpoint.

Clause 17. The dynamic adaptive ballast system of clause 16, wherein said one or more instruments includes a trim sensor for detection of said trim angle.

Clause 18. The dynamic adaptive ballast system of clause 1, wherein said translation stage is arranged to translate said weight ballast laterally within said hull.

Clause 19. The dynamic adaptive ballast system of clause 18, having:
a data acquisition system; and one or more instruments for monitoring by said data acquisition system.

Clause 20. The dynamic adaptive ballast system of clause 19, wherein said one or more instruments includes a roll sensor that is monitored by said data acquisition system.

Clause 21. The dynamic adaptive ballast system of clause 20, wherein said data acquisition system includes a controller that receives a signal from said roll sensor for control of said positioning system.

Clause 22. The dynamic adaptive ballast system of clause 20, wherein said data acquisition system includes a controller configured to control a roll angle of said hull by lateral translation of said weight ballast using said positioning system.

Clause 23. The dynamic adaptive ballast system of clause 22, having a remote actuated clamp operatively coupled to said controller for securing said translation stage in a fixed relationship with said hull.

Clause 24. The dynamic adaptive ballast system of clause 22, having a manual interface for manual control of said positioning system; and a switch for selecting one of said controller and said manual interface for control of said positioning system.

Clause 25. The dynamic adaptive ballast system of clause 22, wherein said controller is configured in a closed loop control process wherein a lateral location of said weight ballast within said hull is a manipulated variable and said roll sensor is a feedback element.

Clause 26. The dynamic adaptive ballast system of clause 25, wherein said one or more instruments includes a position sensor that detects a representative lateral location of said weight ballast for said lateral location of said weight ballast within said hull.

Clause 27. The dynamic adaptive ballast system of clause 22, where said one or more instruments includes a velocity sensor that outputs a velocity signal based on an axial velocity of said hull; and said controller detects an output from said roll sensor and targets a roll setpoint for said roll sensor that is a function of said axial velocity of said hull.

Clause 28. The dynamic adaptive ballast system of clause 22, where said one or more instruments includes an acceleration sensor that outputs an acceleration signal based on a lateral acceleration of said hull; and said controller detects an output from said roll sensor and targets a roll setpoint for said roll sensor that is a function of said lateral acceleration of said hull.

Clause 29. The dynamic adaptive ballast system of clause 22, wherein said controller adjusts a trim angle of a boat motor based on a roll angle setpoint.

Clause 30. The dynamic adaptive ballast system of clause 29, wherein said one or more instruments includes a trim sensor for detection of said trim angle.

Clause 31. The dynamic adaptive ballast system of clause 1, wherein said translation stage is arranged to translate said weight ballast axially and laterally within said hull.

Clause 32. The dynamic adaptive ballast system of any one of clauses 1-31, wherein said positioning system includes a hydraulic actuator for translating said translation stage.

Clause 33. The dynamic adaptive ballast system of any one of clauses 1-31, wherein said weight ballast is one of a battery and a plurality of batteries.

Clause 34. The dynamic adaptive ballast system of clause 33, wherein said watercraft is a pontoon boat.

Clause 35. The dynamic adaptive ballast system of clause 34, wherein said hull of said pontoon boat includes a middle pontoon disposed between two outer pontoons, said translation stage being seated within said middle pontoon.

Clause 36. A method for adaptive ballasting of a watercraft, including providing a controller; and providing instructions on a tangible, non-transitory medium for execution by said controller, said instructions including acquiring a signal indicative of a velocity of said watercraft; establishing a pitch setpoint for said watercraft based on said velocity; and controlling a translation stage for translating a weight ballast to target acquisition of a signal generated from a pitch sensor that is indicative of said pitch setpoint.

Clause 37. The method of clause 36, said instructions including acquiring a signal indicative of an axial acceleration of said watercraft; establishing said pitch setpoint for said watercraft based on said axial acceleration; and controlling a translation stage for translating a weight ballast to target acquisition of a signal generated from a pitch sensor that is indicative of said pitch setpoint.

Clause 38. The method of clause 37, said instructions including: acquiring a signal indicative of a lateral acceleration of said watercraft; establishing a roll setpoint for said watercraft based on said axial acceleration; and controlling said translation stage for translating a weight ballast to target acquisition of a signal generated from a roll sensor that is indicative of said roll setpoint.

Clause 39. A watercraft having a hull; and a dynamic adaptive ballast system having a translation stage seated within the hull; a weight ballast mounted to the translation stage; and a positioning system coupled to the translation stage to selectively position the translation stage and the weight ballast within the hull.

Clause 40. The watercraft of clause 39, wherein the dynamic adaptive ballast system further comprises a remote actuated clamp for securing the translation stage in a fixed relationship with the hull.

Clause 41. The watercraft of clause 39, wherein the translation stage is arranged to translate the weight ballast axially within the hull.

Clause 42. The watercraft of clause 39, wherein the translation stage is arranged to translate the weight ballast laterally within the hull.

Clause 43. The watercraft of clause 39, wherein the dynamic adaptive ballast system further comprises a data acquisition system; and one or more instruments for monitoring by the data acquisition system.

Clause 44. The watercraft of clause 43, wherein the one or more instruments includes a pitch sensor that is monitored by the data acquisition system.

Clause 45. The watercraft of clause 44, wherein the data acquisition system includes a controller that receives a signal from the pitch sensor for control of the positioning system.

Clause 46. The watercraft of clause 44, wherein the data acquisition system includes a controller configured to control a pitch angle of the hull by axial translation of the weight ballast using the positioning system.

Clause 47. The watercraft of clause 46, wherein the dynamic adaptive ballast system further comprises a remote actuated clamp operatively coupled to the controller for securing the translation stage in a fixed relationship with the hull.

Clause 48. The watercraft of clause 46, wherein the dynamic adaptive ballast system further comprises a manual interface for manual control of the positioning system; and a switch for selecting one of the controller and the manual interface for control of the positioning system.

Clause 49. The watercraft of clause 46, wherein the controller is configured in a closed loop control process wherein an axial location of the weight ballast within the hull is a manipulated variable and the pitch sensor provides hull pitch data as a feedback element.

Clause 50. The watercraft of clause 49, wherein the one or more instruments includes a position sensor that detects a representative axial location of the weight ballast for the axial location of the weight ballast within the hull.

Clause 51. The watercraft of clause 39, wherein the weight ballast is one of a battery and a plurality of batteries.

Clause 52. The watercraft of clause 39, wherein the hull is a pontoon, and the watercraft is a pontoon boat.

Clause 53. A watercraft having: a hull; a positioning system for selectively positioning a weight ballast within the hull; and a controller configured to control a pitch angle of the hull by axial translation of the weight ballast using the positioning system.

Clause 54. The watercraft of clause 53, wherein the controller is further configured to control a roll angle of the hull by lateral translation of the weight ballast using the positioning system.

Clause 55. A method for adaptive ballasting of a watercraft, comprising:
providing a controller; and providing instructions on a tangible, non-transitory medium for execution by the controller, the instructions including: acquiring a signal indicative of a velocity of the watercraft; establishing a pitch setpoint for the watercraft based on the velocity; and controlling a translation stage for translating a weight ballast to target acquisition of a signal generated from a pitch sensor that is indicative of the pitch setpoint.

Clause 56. The method of clause 55, the instructions including: acquiring a signal indicative of an axial acceleration of the watercraft; establishing the pitch setpoint for the watercraft based on the axial acceleration; and controlling a translation stage for translating a weight ballast to target acquisition of a signal generated from a pitch sensor that is indicative of the pitch setpoint.

Clause 57. The method of clause 56, said instructions having: acquiring a signal indicative of a lateral acceleration of the watercraft; establishing a roll setpoint for said watercraft based on said axial acceleration; and controlling the translation stage for translating a weight ballast to target acquisition of a signal generated from a roll sensor that is indicative of the roll setpoint.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

What is claimed is:

1. A watercraft comprising:
a hull; and
a dynamic adaptive ballast system comprising:
a translation stage seated within the hull;
a weight ballast mounted to the translation stage; and
a positioning system coupled to the translation stage to selectively position the translation stage and the weight ballast within the hull.

2. The watercraft of claim 1, wherein the dynamic adaptive ballast system further comprises a remote actuated clamp for securing the translation stage in a fixed relationship with the hull.

3. The watercraft of claim 1, wherein the translation stage is arranged to translate the weight ballast axially within the hull.

4. The watercraft of claim 1, wherein the translation stage is arranged to translate the weight ballast laterally within the hull.

5. The watercraft of claim 1, wherein the dynamic adaptive ballast system further comprises a data acquisition system; and one or more instruments for monitoring by the data acquisition system.

6. The watercraft of claim 5, wherein the one or more instruments includes a pitch sensor that is monitored by the data acquisition system.

7. The watercraft of claim 6, wherein the data acquisition system includes a controller that receives a signal from the pitch sensor for control of the positioning system.

8. The watercraft of claim 6, wherein the data acquisition system includes a controller configured to control a pitch angle of the hull by axial translation of the weight ballast using the positioning system.

9. The watercraft of claim 8, wherein the dynamic adaptive ballast system further comprises a remote actuated clamp operatively coupled to the controller for securing the translation stage in a fixed relationship with the hull.

10. The watercraft of claim 8, wherein the one or more instruments includes a velocity sensor that outputs a velocity signal based on an axial velocity of the hull; and the controller detects an output from the pitch sensor and targets a pitch setpoint for the pitch sensor that is a function of the axial velocity of the hull.

11. The watercraft of claim 8, wherein the dynamic adaptive ballast system further comprises a manual interface for manual control of the positioning system; and a switch for selecting one of the controller and the manual interface for control of the positioning system.

12. The watercraft of claim 8, wherein the controller is configured in a closed loop control process wherein an axial location of the weight ballast within the hull is a manipulated variable and the pitch sensor provides hull pitch data as a feedback element.

13. The watercraft of claim 12, wherein the one or more instruments includes a position sensor that detects a representative axial location of the weight ballast for the axial location of the weight ballast within the hull.

14. The watercraft of claim 1, wherein the weight ballast is one of a battery and a plurality of batteries.

15. The watercraft of claim 1, wherein the hull is a pontoon, and the watercraft is a pontoon boat.

16. A watercraft comprising:
a hull;
a positioning system for selectively positioning a weight ballast within the hull; and
a controller configured to control a pitch angle of the hull by axial translation of the weight ballast using the positioning system.

17. The watercraft of claim 16, wherein the controller is further configured to control a roll angle of the hull by lateral translation of the weight ballast using the positioning system.

18. A method for adaptive ballasting of a watercraft, comprising:
providing a controller; and
providing instructions on a tangible, non-transitory medium for execution by the controller, the instructions comprising:
acquiring a signal indicative of a velocity of the watercraft;
establishing a pitch setpoint for the watercraft based on the velocity; and
controlling a translation stage for translating a weight ballast to target acquisition of a signal generated from a pitch sensor that is indicative of the pitch setpoint.

19. The method of claim 18, the instructions comprising:
acquiring a signal indicative of an axial acceleration of the watercraft;
establishing the pitch setpoint for the watercraft based on the axial acceleration; and
controlling a translation stage for translating a weight ballast to target acquisition of a signal generated from a pitch sensor that is indicative of the pitch setpoint.

20. The method of claim 19, said instructions comprising:
acquiring a signal indicative of a lateral acceleration of the watercraft;
establishing a roll setpoint for said watercraft based on said axial acceleration; and
controlling the translation stage for translating a weight ballast to target acquisition of a signal generated from a roll sensor that is indicative of the roll setpoint.
